(19) United States
(12) Patent Application Publication
(10) Pub. No.: US 2009/0164638 A1
(43) Pub. Date: Jun. 25, 2009

(54) SYSTEM AND METHOD FOR UPLINK RESOURCE ALLOCATION IN MOBILE INTERNET

(75) Inventors: Choul Soo Jang, Daejeon (KR); Joong Bae Kim, Daejeon (KR); Kyeong Ho Lee, Daejeon (KR)

Correspondence Address: STAAS & HALSEY LLP, SUITE 700, 1201 NEW YORK AVENUE, N.W., WASHINGTON, DC, 20005, US

(73) Assignee: ELECTRONICS AND TELECOMMUNICATIONS RESEARCH INSTITUTE, Daejeon (KR)

(21) Appl. No.: 12/342,999

(22) Filed: Dec. 23, 2008

(30) Foreign Application Priority Data
Dec. 24, 2007 (KR) 10-2007-0136275

(51) Int. Cl. G06F 15/173

(52) U.S. Cl. 709/226

(57) ABSTRACT

A system for uplink resource allocation in mobile Internet for remote-controlling robots includes a schedule policy table for storing therein priorities assigned to the robots to support required image qualities of images received from the robots and maximum allocatable uplink resource amounts for the robots; and a scheduler for allocating uplink resources to the robots based on the priorities, the maximum allocatable uplink resource amounts and required bandwidths received from the robots. Each of the robots includes a camera for taking the images; an encoder for encoding the images taken by the camera; and a mobile Internet terminal, having a transmission queue for temporarily storing therein the encoded images, for transmitting the encoded image in the transmission queue to a remote control center via the uplink resources allocated based on the required bandwidth, which is calculated based on status of the transmission queue.

### CROSS-REFERENCE(S) TO RELATED APPLICATION(S)

The present invention claims priority of Korean Patent Application No. 10-2007-0136275, filed on Dec. 24, 2007, which is incorporated herein by reference.

### FIELD OF THE INVENTION

The present invention relates to a system and method for uplink resource allocation in the mobile Internet; and, more particularly, to a system and method for uplink resource allocation in the mobile Internet to control multiple robots remotely.

### BACKGROUND OF THE INVENTION

As well known in the art, direct or remote control of a robot in an unmanned vehicle is a work of vision.

A remote robot control system controls a robot by using images provided from cameras mounted to the robot. Hence, in order to remotely control the robot in real time, real-time streams of the images obtained by the cameras mounted to the robot need to be transmitted to a user in a remote place.

In the past time, data rates in wireless communications were too low, e.g., several Kbps, to transmit the real-time streams of the images for use in a wireless remote control. However, wireless communications technologies have been rapidly developed in recent to provide high data rates. In particular, WiMax (Worldwide Interoperability for Microwave Access), which is a high-speed wireless mobile Internet technology locating in a middle area between a mobile phone and a wireless LAN (Local Area Network), employs OFDMA (Orthogonal Frequency Division Multiple Access), thereby allowing high-speed data communications of several Mbps with low costs while supporting user's mobility.

Though WiMax systems provide a wider bandwidth than conventional wireless mobile communications systems do, the bandwidth of the WiMax systems is still in sufficient to transmit real-time images from multiple robots. Therefore, a user in a remote control center needs to set priorities of the robots according to roles of the robots and perform an appropriate uplink scheduling according to the priorities. To be specific, the user needs to assign high priorities, middle priorities and low priorities to robots transmitting high-resolution images for use in intensive surveillances, robots transmitting middle-resolution images for use in controlling other robots and robots transmitting low-resolution images, respectively, and based thereon, perform an uplink scheduling to display the images on monitors in the remote control center.

In the uplink scheduling, it should be noted that, the WiMax system uses various modulation and coding schemes according to wireless communications environments, e.g., a distance from a base station to a terminal, a signal-to-noise ratio and the like, and thus, different resource amounts need to be allocated to terminals in order to provide an identical bandwidth to the terminals.

However, conventional uplink schedulers allocate uplink resources according to scheduling policies which do not take into consideration the priorities set by the user according to the roles of the robots, and thus user's intention cannot be reflected on the uplink scheduling. Further, the conventional uplink schedulers have drawbacks in that, since the wireless communications environments are taken into consideration in resource allocation in order to provide desired bandwidths to terminals, sufficient resources cannot be allocated to terminals because too much resources are allocated to terminals in bad wireless communications environments, or, the resources are wasted because unnecessarily too much resources are allocated to terminals in good wireless communications environments.

### SUMMARY OF THE INVENTION

In view of the above, the present invention provides a system and method for uplink resource allocation in the mobile Internet, in which uplink resources are allocated efficiently to control multiple robots remotely.

In accordance with an aspect of the invention, there is provided a system for uplink resource allocation in mobile Internet for remote-controlling robots, the system including:

a schedule policy table for storing therein priorities assigned to the robots to support required image qualities of images received from the robots and maximum allocatable uplink resource amounts for the robots; and

a scheduler for allocating uplink resources to the robots based on the priorities, the maximum allocatable uplink resource amounts and required bandwidths received from the robots.

In accordance with another aspect of the invention, there is provided a method for uplink resource allocation in mobile Internet for remote-controlling robots, the method including:

storing, in a schedule policy table, priorities assigned to the robots to support required image qualities of images received from the robots and maximum allocatable uplink resource amounts for the robots;

querying the robots for required bandwidths for use in transmitting the images;

allocating uplink resources to the robots based on the priorities, the maximum allocatable uplink resource amounts and the required bandwidths received from the robots;

transmitting resource allocation result to the robots; and

displaying the images received from the robots via the allocated uplink resources.

According to the present invention, the uplink resource allocation in the mobile Internet system, e.g., the WiMax system, can be performed efficiently by considering required image qualities and status of communication channels assigned to the robots.

### BRIEF DESCRIPTION OF THE DRAWINGS

The above features of the present invention will become apparent from the following description of embodiments, given in conjunction with the accompanying drawings, in which:

FIG. 1 illustrates a schematic view of a system for uplink resource allocation in mobile Internet to control multiple robots remotely in accordance with an embodiment of the present invention;

FIG. 2 illustrates a conceptual view of resource allocation in a WiMax system;

FIG. 3 illustrates an exemplary view of resource allocation using MAP messages in the WiMax system;

FIG. 4 illustrates an explanatory view of an MAP-IE in the WiMax system;

FIG. 5 illustrates a detailed block diagram of the system of FIG. 1;

FIG. 6 illustrates an exemplary view of an input screen via which a user sets priorities and uplink resource allocation ratios;

FIG. 7 illustrates an exemplary view of a scheduling policy table;

FIG. 8 illustrates message flows for uplink resource allocation in accordance with the embodiment of the present invention;

FIG. 9 illustrates a flowchart of an uplink resource allocation procedure in a mobile Internet base station; and

FIG. 10 illustrates a flowchart of a procedure in a mobile Internet terminal for the uplink resource allocation.

### DETAILED DESCRIPTION OF THE EMBODIMENTS

Hereinafter, embodiments of the present invention will be described in detail with reference to the accompanying drawings, which form a part hereof.

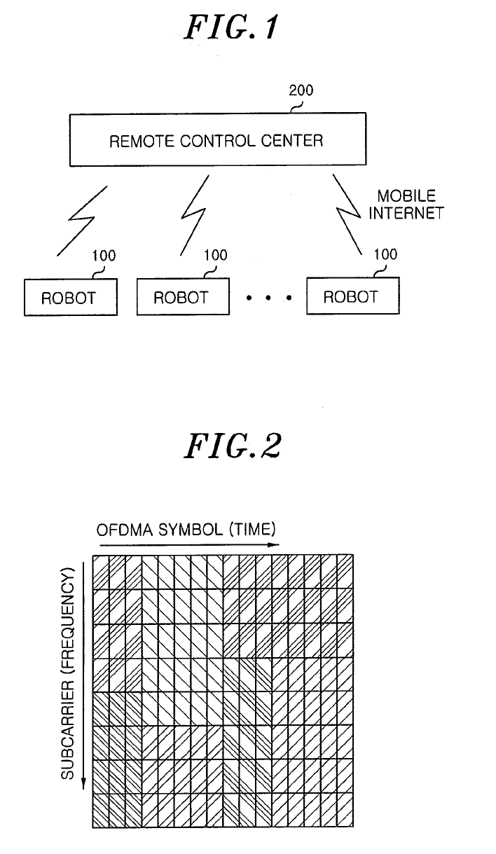

FIG. 1 illustrates a schematic view of a system for uplink resource allocation in mobile Internet to control multiple robots remotely in accordance with an embodiment of the present invention.

As shown in FIG. 1, the system includes robots 100 and a remote control center 200.

Each of the robots 100 and the remote control center 200 have therein a mobile Internet terminal and a mobile Internet base station, respectively, and thus the robots 100 and the remote control center 200 are wirelelssly connected via a mobile Internet network, e.g., a WiMax network.

In operation, each of the robots 100 encodes images taken by a camera mounted thereto to transmit encoded images to the remote control center 200 via the mobile Internet terminal, and, the remote control center 200 monitors the images received from the robots 100 and checks circumstances of the robots 100 to transmit control signals to the robots 100. As such, a user in the remote control center 200 can simultaneously remote-control the robots 100 distanced several kilometers from the remote control center 200.

One of the most representative mobile Internet technologies having been or being developed is the WiMax. For eases of explanation, the system and method of the present invention will be described, in this disclosure, those for the WiMax system. However, it should be noted that the present invention can be also applicable to any other mobile Internet system obvious to those skilled in the art without departing from the scope of the present invention.

The WiMax employs the OFDMA, in which a terminal does not exclusively occupy all subcarriers but a base station allocates different sets of subcarriers to multiple terminals.

The OFDMA is classified into OFDM-FDMA (Orthogonal Frequency Division Multiplexing-Frequency Division Multiple Access) in which different frequency bands are assigned to multiple terminals, OFDM-TDMA (Orthogonal Frequency Division Multiplexing-Time Division Multiple Access) in which different time slots are assigned to multiple terminals and OFDM-CDMA (Orthogonal Frequency Division Multiplexing-Code Division Multiple Access) in which different spreading codes are assigned to multiple terminals.

The WiMax uses the OFDM-FDMA and the OFDM-TDMA together, thus allowing flexible bandwidth allocation. FIG. 2 illustrates a conceptual view of resource allocation in the WiMax system. As shown in FIG. 2, user data can be laid on a rectangular sub-region corresponding to a specific time slot on the X-axis and a specific frequency band on the Y-axis, which allows flexible resource allocation.

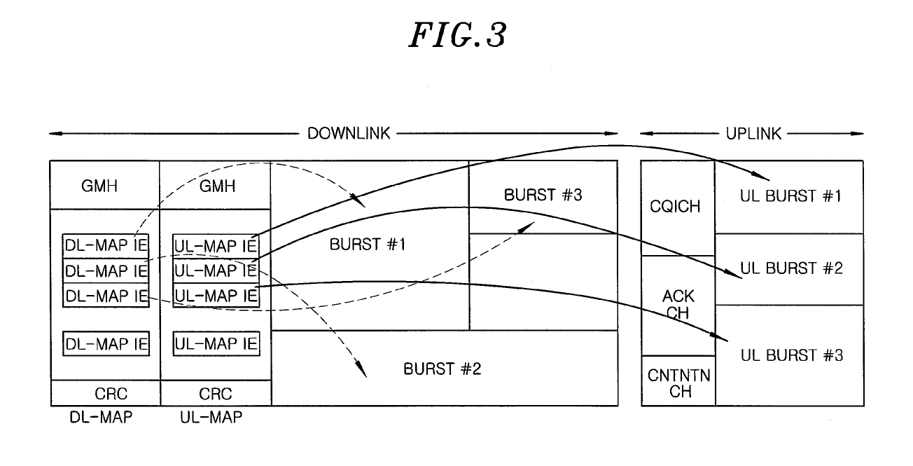

FIG. 3 illustrates an exemplary view of resource allocation using MAP messages in the WiMax system. The MAP messages include a DL-MAP (Downlink-MAP) and an UL-MAP (Uplink-MAP) and for downlink and uplink, respectively. In the WiMax system, scheduling for dynamic bandwidth allocation is performed for each frame by using the DL-MAP and the UL-MAP. Each of the DL-MAP and the UL-MAP contains therein several MAP-IEs (Information Elements), each of which serves as a pointer indicating a position and a size of a data burst.

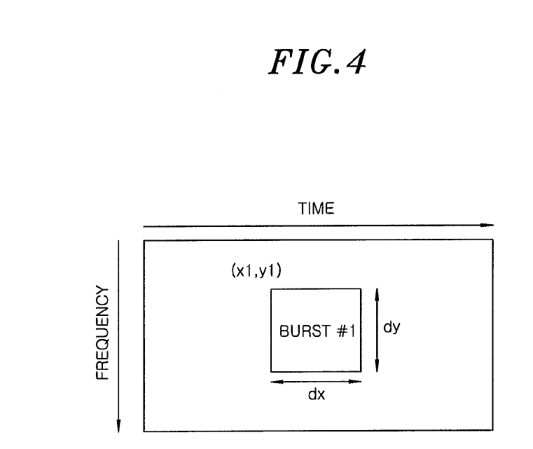

FIG. 4 illustrates an explanatory view of a MAP-IE in the WiMax system. Each MAP-IE contains therein a CID (Connection ID) of 16 bits and location information indicating a start point (x1,y1) and a size (dx,dy), as shown in FIG. 4.

The WiMax uses various modulation and coding schemes according to wireless communications environments, e.g., a distance from a base station to a terminal, a signal-to-noise ratio and the like. For example, QPSK (Quadrature Phase Shift Keying), 16 QAM (16-Quadrature Amplitude Modulation) and 64 QAM (64-Quadrature Amplitude Modulation) can be selectively used for download modulation, and, the QPSK and the 16 QAM can be selectively used for upload modulation. Accordingly, scheduling for efficient resource allocation, i.e., efficient time and frequency allocation, plays an important role in adaptive modulation and coding according to different channel environment of users.

As for the downlink, resource confliction does not occur because the base station solely downloads data in the WiMax. The base station transmits the data to the terminals along with the DL-MAP containing therein the DL-MAP-IEs, and each of the terminals refers the DL-MAP-IEs to receive data transmitted thereto. Download scheduling is performed at the base station in consideration of QoS (Quality of Service), fairness, throughput and the like.

As for the uplink, the resource allocation for the terminals, i.e., which terminal transmits data at a specific time slot via a specific subcarrier, is necessary because the terminals try to transmit data simultaneously. The Wimax supports three uplink resource allocation schemes, which include a request/grant method, a polling method and a reservation method. In the request/grant method, the terminals request slots and the base station grants the requests. In the polling method, the base station asks the terminals whether the terminals have data to be transmitted. In the reservation method, the base station and the terminals negotiate to reserve the resources during flow setup times therebetween.

To support the above-described uplink resource allocation schemes, various uplink scheduling schemes, e.g., an unsolicited grant service (hereinafter, simply referred to as “UGS”), a real-time polling service (hereinafter, simply referred to as “rtPS”), an extended real-time polling service (hereinafter, simply referred to as “ertPS”), a best effort service (hereinafter, simply referred to as “BES”) and the like, have been proposed.

The UGS is used, as in CBR (Constant Bit Rate) in ATM (Asynchronous Transfer Mode), when transmitting fixed sized data periodically. In the UGS, data sizes and transmission intervals are determined during the flow setup times between the base station and the terminals via a negotiation therebetween.

Meanwhile, the rtPS and ertPS are for variable sized data transmission. Both the rtPS and ertPS are polling based services, in which resources are allocated in response to periodic uplink resource allocation requests from the terminals. Accordingly, the terminals can receive appropriate resource amounts according to amounts of data to be transmitted and transmit the data using the resources. To be specific, in the rtPS and ertPS, the resource allocation is performed via a 4-way handshake as follows:

1. The base station transmits a unicast-polling to the terminals.

2. The terminals transmit bandwidth requests to the base station via an uplink in response to the unicast-polling.

3. The base station performs resource allocation for the bandwidth requests and notifies the terminals of resource allocation result.

4. The terminals transmit data to the base station via newly-allocated uplink resources.

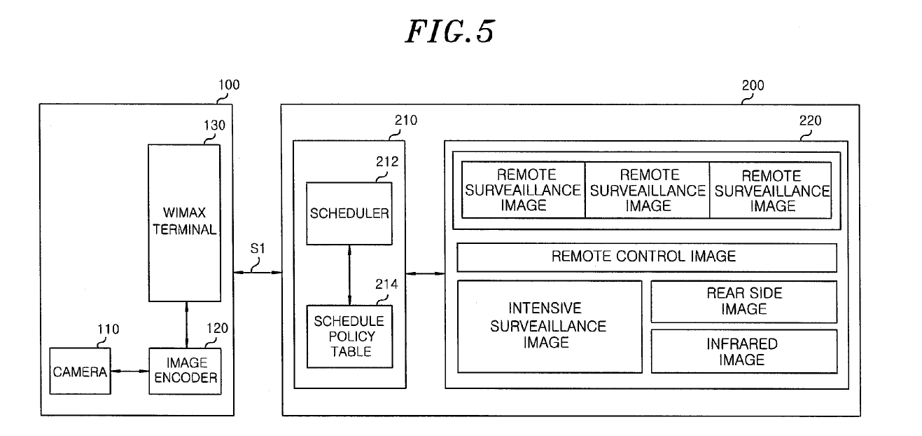

FIG. 5 illustrates a detailed block diagram of the system of FIG. 4.

As shown in FIG. 5, each of the robots 100, which operates according to the control signals received from the remote control center 200, has therein a camera 110, an image encoder 120 and a WiMax terminal 130. The camera 110 takes images and provides the images to the image encoder 120. The image encoder 120 encodes the images received from the camera 110 to generate image data and provides the image data to the WiMax terminal 130. The WiMax terminal 130 calculates a required uplink bandwidth by checking status of a transmission queue (not shown), in which the image data to be transmitted to the remote control center 200 are temporarily stored, and transmits thus calculated required uplink bandwidth to the remote control center 200. After receiving an uplink resource allocation result from the remote control center 200, the WiMax terminal 130 transmits the image data to the remote control center 200 via uplink resources of the mobile Internet, e.g., the WiMax network, allocated thereto.

The remote control center 200, which controls the robots 100 remotely, includes a WiMax base station 210 and a display 220. The WiMax base station 210 has therein a scheduler 212 and a schedule policy table 214.

The WiMax base station 210 receives the image data from the robots 100 and displays the image data on the display 220. The image data may include remote-surveillance images, remote-control images, intensive surveillance images, rear side images and infrared images, and can be selectively and simultaneously displayed on the display 220.

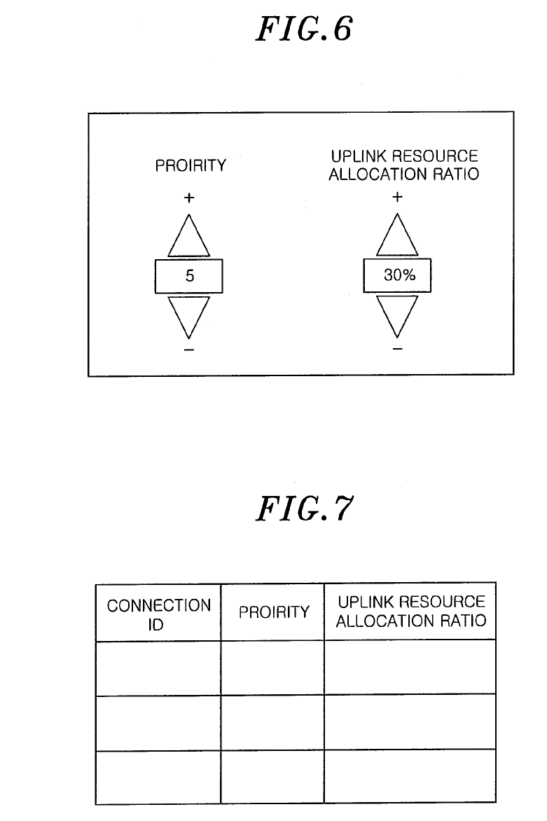

In order to support required image quality of the image data provided from the robots 100, the user in the remote control center 200 sets priorities of the robots 100 and uplink resource allocation ratios, e.g., via an input screen as shown in FIG. 6.

The uplink resource allocation ratios may be, e.g., maximum uplink resource amounts of the robots 100. The maximum uplink resource amount of a specific robot 100 having a specific priority is represented by a relative ratio of the uplink resource amount allocatable to the specific robot 100 to the total uplink resource amount allocatable to robots 100 having the same priorities as that of the specific robot 100. To be specific, if 50% of the total uplink resource amount has already been allocated to robots 100 having the highest priority and the maximum uplink resource amount of a specific robot 100 having the next highest priority is set to 30%, 15% of the total uplink resource amount is allocated to the specific robot 100.

The priorities and uplink resource allocation ratios are stored in the schedule policy table 214, as shown in FIG. 7, to be used by the scheduler 212.

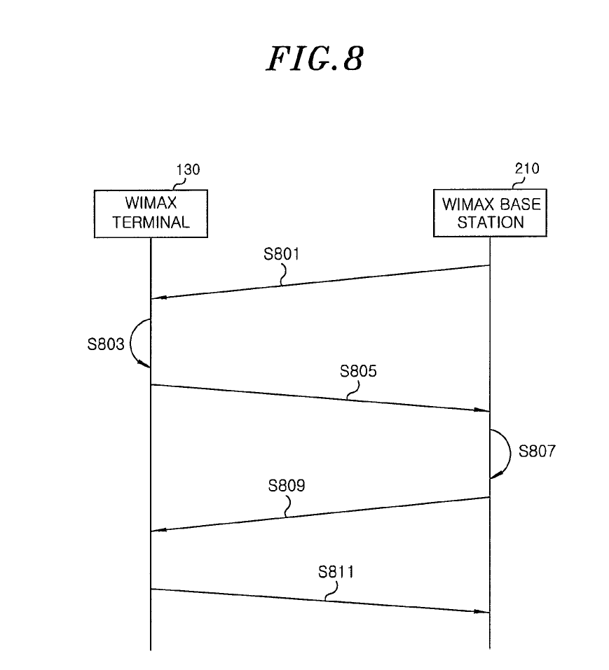

Below, uplink resource allocation procedure in accordance with the embodiment of the present invention will be described with reference to FIG. 8.

FIG. 8 illustrates message flows for uplink resource allocation in accordance with the embodiment of the present invention.

First, the scheduler 212 in the WiMax base station 210 periodically queries, e.g., via the rtPS, the WiMax terminal 130 in each of the robots 100 for a required bandwidth (step S801). Here, the scheduler 212 may query for each frame or for each specific time interval set in consideration of overhead in transmission and reception of the image data.

In response to the query from the scheduler 212, the WiMax terminal 130 calculates the required bandwidth by checking the status of the transmission queue (not shown) in which the image data generated by the image encoder 120 are temporarily stored (step S803). The WiMax terminal 130 transmits thus calculated required bandwidth to the scheduler 212 (step S805).

After that, the scheduler 212 performs the uplink resource allocation by using the required bandwidths received from the robots 100 (step S807), and, transmits the uplink resource allocation result to the WiMax terminal 130 (step S809). The WiMax terminal 130 transmits the image data to the scheduler 212 by using the uplink resources allocated thereto (step S811).

As such, the uplink resource allocation in the WiMax system can be performed efficiently by considering required image qualities and status of communication channels assigned to the robots 100.

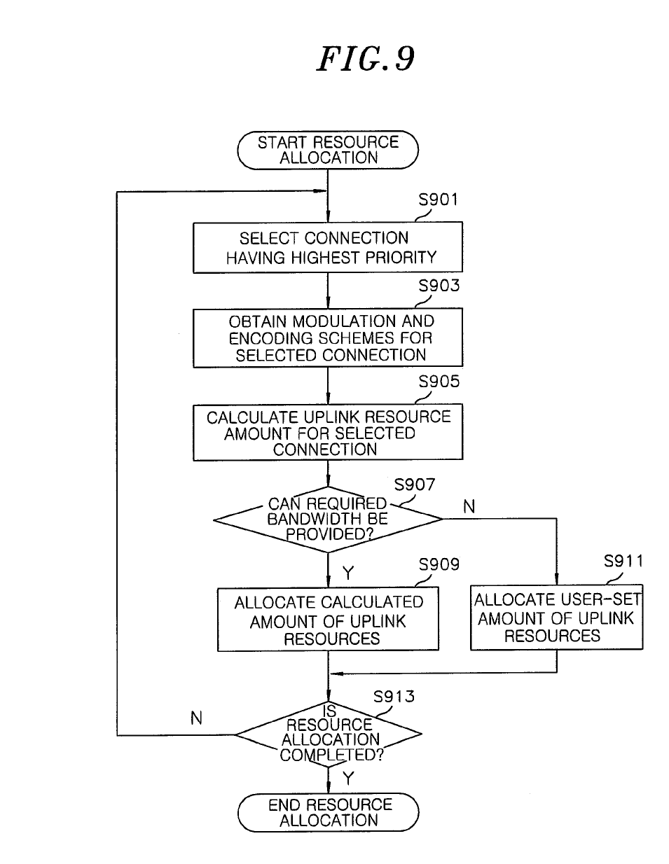

FIG. 9 illustrates a flowchart of an uplink resource allocation procedure in the WiMax base station in the remote control center 200 using the required bandwidths received from the robots 100.

First, among connections to which the uplink resources are not yet allocated, a connection having the highest priority is selected (step S901). Then, modulation and coding schemes set for the selected connection are obtained (step S903), and the uplink resource amount to support the required bandwidth appropriate for the obtained modulation and coding schemes is calculated (step S905).

After that, it is determined whether the required bandwidth for the connection can be provided by using, among currently remaining uplink resources, uplink resource amount equal to or less than the uplink resource allocation ratio for the connection set by the user (step S907).

If it is determined in the step S907 that the required bandwidth can be provided, calculated amount of the uplink resources is allocated to the connection (step S909). Meanwhile, if it is determined in the step S907 that the required bandwidth cannot be provided, the user-set amount of the uplink resources is allocated to the connection (step S911).

Thereafter, it is determined whether the uplink resource allocation for all connection is completed (step S913). If it is determined in the step S913 that the uplink resource allocation is not completed, the control returns to the step S901.

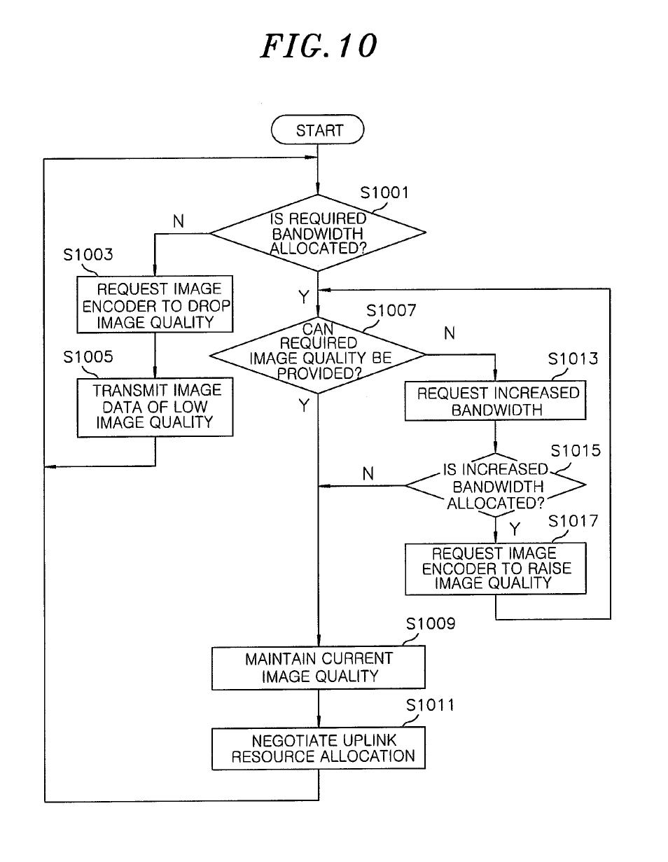

FIG. 10 illustrates a flowchart of a procedure in the WiMax terminal 130 in each of the robots 100 for the uplink resource allocation.

First, it is determined whether the required bandwidth is allocated to the WiMax terminal 130 with reference to the uplink resource allocation result received from the WiMax base station 210 (step S1001).

If it is determined in the step S1001 that the uplink resource amount allocated to the WiMax terminal 130 is less than the required bandwidth, the WiMax terminal 130 requests the image encoder 120 to increase the compression ratio to drop the image quality, thereby reducing the image data size to be transmitted to the WiMax base station 210 (step S1003) In response to the request, the image encoder 120 provides image data, of which image quality is dropped, to the WiMax terminal 130, and the WiMax terminal 130 transmits the image data to the WiMax base station 210 (step S1005).

If it is determined in the step S1001 that the required bandwidth is allocated to the WiMax terminal 130, it is determined whether the required image quality can be provided with the currently allocated bandwidth (step S1007).

If it is determined in the step S1007 that the required image quality can be provided with the currently allocated bandwidth, current image quality is maintained (step S1009), and the WiMax terminal 130 periodically negotiates the uplink resource allocation with the scheduler 212 in the WiMax base station 210 (step S1011).

Meanwhile, if it is determined in the step S1007 that the required image quality cannot be provided with the currently allocated bandwidth, the WiMax terminal 130 increases the required bandwidth by a specific ratio and requests the scheduler 212 of the increased required bandwidth at the next negotiation (step S1013). Thereafter, it is determined whether the increased required bandwidth is allocated to the WiMax terminal 130 (step S1015). If it is determined in the step S1015 that the increased required bandwidth is allocated, the WiMax terminal 130 requests the image encoder 120 to raise the image quality (step S1017). If it is determined in the step S1015 that the increased required bandwidth is not allocated, the control goes to the step S1009 to maintain the current image quality.

The WiMax terminal 130 repeatedly performs the above-described process while increasing the required bandwidth until the WiMax terminal 130 can provide an initial required image quality. Accordingly, if communications environment becomes better or unused uplink resource amount increases, the initial required image quality can be provided.

While the invention has been shown and described with respect to the embodiments, it will be understood by those skilled in the art that various changes and modification may be made without departing from the scope of the invention as defined in the following claims.

What is claimed is:

1. A system for uplink resource allocation in mobile Internet for remote-controlling robots, the system comprising:
a schedule policy table for storing therein priorities assigned to the robots to support required image qualities of images received from the robots and maximum allocatable uplink resource amounts for the robots; and
a scheduler for allocating uplink resources to the robots based on the priorities, the maximum allocatable uplink resource amounts and required bandwidths received from the robots.

2. The system of claim 1, wherein the scheduler selects a connection associated with a robot to which highest priority is assigned; obtains modulation and coding schemes for the connection; calculates uplink resource amount to support a bandwidth for the modulation and coding schemes; and allocates to the connection the calculated amount of the uplink resources, if the calculated uplink resource amount is equal to or less than the maximum allocatable uplink resource amount for the robot and unused amount of the uplink resources is sufficient to support the bandwidth for the modulation and coding schemes.

3. The system of claim 2, wherein the scheduler allocates to the connection the uplink resources corresponding to the maximum allocatable uplink resource amount for the robot, if the calculated uplink resource amount is greater than the maximum allocatable uplink resource amount for the robot or unused amount of the uplink resources is insufficient to support the bandwidth for the modulation and coding schemes.

4. The system of claim 1, wherein the uplink resources are resources of the mobile Internet or WiMax (Worldwide Interoperability for Microwave Access).

5. The system of claim 1, wherein each of the robots includes:
a camera for taking the images;
an encoder for encoding the images taken by the camera; and
a mobile Internet terminal, having a transmission queue for temporarily storing therein the encoded images, for transmitting the encoded image in the transmission queue to a remote control center via the uplink resources allocated based on the required bandwidth, which is calculated based on status of the transmission queue.

6. A method for uplink resource allocation in mobile Internet for remote-controlling robots, the method comprising:
storing, in a schedule policy table, priorities assigned to the robots to support required image qualities of images received from the robots and maximum allocatable uplink resource amounts for the robots;
querying the robots for required bandwidths for use in transmitting the images;
allocating uplink resources to the robots based on the priorities, the maximum allocatable uplink resource amounts and the required bandwidths received from the robots;
transmitting resource allocation result to the robots; and
displaying the images received from the robots via the allocated uplink resources.

7. The method of claim 6, wherein allocating the uplink resources includes:
selecting a connection associated with a robot to which highest priority is assigned;
obtaining modulation and coding schemes for the connection;
calculating uplink resource amount to support a bandwidth for the modulation and coding schemes; and
allocating to the connection the calculated amount of the uplink resources, if the calculated uplink resource amount is equal to or less than the maximum allocatable uplink resource amount for the robot and unused amount of the uplink resources is sufficient to support the bandwidth for the modulation and coding schemes.

8. The method of claim 7, wherein allocating the uplink resources further includes:
allocating to the connection the uplink resources corresponding to the maximum allocatable uplink resource amount for the robot, if the calculated uplink resource amount is greater than the maximum allocatable uplink resource amount for the robot or unused amount of the uplink resources is insufficient to support the bandwidth for the modulation and coding schemes.

9. The method of claim 6, wherein each of the robots maintains current image quality if amount of the allocated uplink resources corresponds to the required bandwidth and is sufficient to support required image quality.

10. The method of claim 6, wherein, each of the robots increases the required bandwidth by a specific ratio if the amount of the allocated uplink resources is insufficient to support the required image quality, and, if the amount of the allocated uplink resources is increased in response to the increased required bandwidth, each of the robots raises the current image quality.
